(19) United States
(12) Patent Application Publication
(10) Pub. No.: US 2003/0103454 A1
(43) Pub. Date: Jun. 5, 2003

(54) QoS controller

(75) Inventors: Stefan Wahl, Schwieber-dingen (DE); Elmar Schmidberger, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/299,788

(22) Filed: Nov. 20, 2002

(30) Foreign Application Priority Data
Nov. 30, 2001 (EP) 01 440 406.5

(51) Int. Cl. H04L 1/00

(52) U.S. Cl. 370/229; 370/330

(57) ABSTRACT

The object of the invention is to provide a simplified QoS guarantee in bidirectional point-to-multipoint access networks, such as LMDS. This object is attained by a QoS controller containing at least one software module which is adapted to perform at least one QoS processing step for both the uplink and the downlink. In the case of the QoS controller according to the invention, the same QoS controller and the same software module are used for at least a major part of the connection both in the uplink and the downlink. This has the advantage, inter alia, that a nearly symmetrical behavior is achieved for the uplink and downlink.

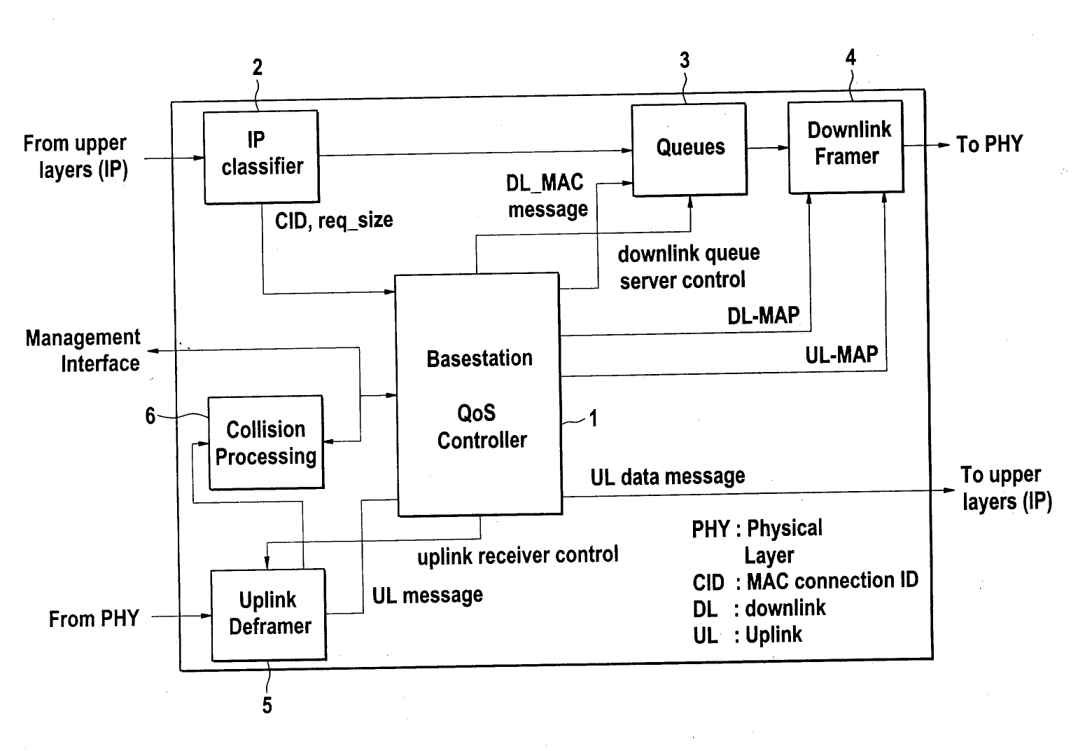

### TECHNICAL FIELD

This invention relates to a QoS controller. The invention is based on a priority application EP 01 440 406.5, which is hereby incorporated by reference.

### BACKGROUND OF THE INVENTION

In bidirectional wireline or wireless point-to-multipoint access networks, such as LMDS, HFR, or HFC, a Quality of Service (QoS) is to be guaranteed for traffic in both directions of transmission; LMDS=Local Multipoint Distribution System, HFR=Hybrid Fiber/Radio, HFC=Hybrid Fiber/Coax. LMDS is implemented, for example, as a local network with a radio base station and a number of radio terminals which communicate with each other. The transmission channels used lie in the 20-40 GHz band, for example.

The connections in the so-called downlink, i.e., from a center, e.g., a base station, to a number of terminals, differ from the connections in the so-called uplink, i.e., from the terminals to the center, by the access protocol, the data rate, etc. The downlink uses TDM, for example, and the uplink uses TDMA, CDMA, FDMA, or combinations thereof, for example; TDM=Time Division Multiplexing, TDMA=Time Division Multiple Access, CDMA=Code Division Multiple Access, FDMA=Frequency Division Multiple Access. In the uplink, a MAC protocol is used, for example; MAC=Medium Access Control. The MAC protocol regulates, among other things, the allocation of resources, such as transmission rights, bandwidths, or data rates for terminals which have access to the same medium at the same time.

To provide QoS in the downlink for an information packet received over the Internet, for example, the base station includes a QoS controller incorporating specific software. To provide QoS in the uplink, i.e., from the terminals to the base station and for onward transmission over the Internet, another QoS controller with other specific software is present in the base station. Thus, two different hardware QoS controllers containing different software are available for the uplink and downlink.

### SUMMARY OF THE INVENTION

It is an object of the invention to provide a simplified QoS guarantee.

This object is attained by a QoS controller for a bidirectional point-to-multipoint access network, particularly for an LMDS network, comprising at least one software module adapted to perform a QoS processing step for both the uplink and the downlink.

In the case of the QoS controller according to the invention, the same QoS controller and the same software module are used for at least a major part of the connection both in the uplink and in the downlink.

This has the advantage that a nearly symmetrical behavior is achieved for the uplink and downlink. This results in less interference in the transmission channels.

Furthermore, the expenditure on the design and development of the QoS guarantee is reduced. The QoS can be developed faster, whereby costs are saved.

In addition, less space is needed for the implementation. The QoS controller has identical connection data records and smaller dimensions and can be manufactured at lower cost.

As only one QoS controller is present, multiple use of the connection parameters is possible and initialization is simplified. For instance, only one boot process is needed.

Advantageous developments are apparent from the dependent claims and the following description.

An embodiment of the invention will now be explained with reference to the accompanying drawing.

### BRIEF DESCRIPTION OF THE DRAWING

The single Figure of the drawing shows schematically a portion of a base station according to the invention in an LMDS network.

### BEST MODE FOR CARRYING OUT THE INVENTION

The base station comprises a QoS controller 1, a series combination of an IP classifier 2, a buffer 3, and a downlink framer 4 which are all connected to QoS controller 1, and an uplink deframer 5 connected to QoS controller 1. Also provided is a collision detection unit 6 which is connected to QoS controller 1 and has an interface to a management.

IP classifier 2 has one input and two outputs. At the input, IP information packets are received from the Internet; IP=Internet Protocol. In information packets, voice, data, video, Internet web pages, etc. can be transmitted. One of the outputs is connected to buffer 3, and the other to QoS controller 1. IP classifier 2 is provided for extracting pointers transmitted together with and associated with the information packets from the received packet stream, for evaluating these pointers, and for feeding them to buffer 3. MAC connection IDs contained in the pointers, i.e., connection addresses, are transferred to the QoS controller.

Buffer 3 (“queue”) has two data inputs, one control input, and one output. One of the data inputs is connected to IP classifier 2, and the other data input and the control input are connected to QoS controller 1. The output is connected to downlink framer 4. Buffer 3 may consist of one or more memories and may have one or more memory areas. Each memory or area is assigned to a quality-of-service class, for example. Via one of the data inputs, the pointers extracted by the IP classifier 2 are read in. The information packets may be stored in a separate packet memory or also in buffer 3. In the latter case, they are also read in via said one data input. Via the other data input, MAC messages destined for the downlink and generated in QoS controller 1 are fed to buffer 3. Under control of QoS controller 1, which is connected to the control input, the relevant information is made available at the output of buffer 3.

Downlink framer 4 has one data input, two control inputs, and one output. The data input is connected to buffer 3. Via the control inputs, which are connected to QoS controller 1, information about the Medium Access Protocol (MAP), generated in part from uplink information in QoS controller 1, is fed to downlink framer 4. The output is linked by radio to the terminals. Downlink framer 4 serves to compose the downlink frame, i.e., the frame to be transmitted to the terminals. A downlink frame contains, for example, a preamble field, a physical layer field, a MAC field, and a data field. The preamble field serves synchronization purposes, for example. In the MAC field, rights to transmit (“grant messages”), for example, are transmitted. In the data field, differently modulated data packets can be transmitted, such as QPSK-, 16 QAM-, and/or 64 QAM-modulated data. The downlink frame is transmitted to all terminals. Each terminal can receive packets of at least one type of modulation, e.g., QPSK, 16 QAM, and/or 64 QAM.

Uplink deframer 5 has one data input, one control input, and two outputs. The data input is connected to the terminals by radio. The control input is connected to QoS controller 1 and serves to enter information about receiver control in the uplink. One of the outputs is connected to unit 6, and the other to QoS controller 1, which is fed with the messages received in the uplink. One of the functions of uplink deframer 5 is to select received data packets.

Unit 6 serves to detect collisions. When collisions are detected, they are communicated both to the QoS controller and to the management in order to initiate appropriate measures.

QoS controller 1 is implemented, for example, as a processor containing specific software. The processor is, for instance, a microprocessor or a digital signal processor. The software is programmed, for example, in the programming language C or C++. In addition, there may be provided, for example: a RAM, a ROM, a register, a flash memory; the latter elements also in any combination and in multiple numbers.

QoS controller 1 contains at least one software module which is adapted to perform at least one QoS processing step for both the uplink and the downlink.

By means of the software module, QoS controller 1 applies at least essentially the same algorithm for allocations of resources and QoS management in both the uplink and the downlink. 80 to 100%, for example, of the information needed for the allocation of resources, e.g., bandwidth, is derived for both the uplink and the downlink using the same algorithm. Likewise, 80 to 100%, for example, of the information needed for QoS management is derived for both the uplink and the downlink using the same algorithm.

QoS controller 1 has the same implementation of at least the essential functions of a MAC QoS controller for allocations of resources and QoS management in both the uplink and the downlink. The essential functions cover 80 to 100%, for example. Over the uplink, the MAC QoS controller receives from the terminals requests for the transmission of data, for the establishment of a connection, etc., and determines by means of the MAC algorithm transmission rights etc., which are transmitted over the downlink to the terminals. Using the same MAC algorithm, the MAC QoS controller controls the reading of information from buffer 3. In that case, buffer 3 contains several queues which serve to temporarily store differently modulated data packets arranged according to associated quality-of-service classes. In each queue, packets of a particular QoS class are stored, for example. Within a queue, differently modulated packets can be stored. Packets of a higher QoS class, i.e., of higher priority, are read out with preference.

QoS controller 1 serves, inter alia, to grant rights to transmit for the uplink and allocate bandwidths and data rates for the downlink, the grants and allocations being dependent on occupancies of at least one buffer 3, in which information packets to be transmitted and/or associated pointers and/or MAC messages are stored temporarily, and/or on connection parameters and/or on available transmission channel capacities and/or on QoS classes. QoS controller 1 performs the mapping of the data packets to be transmitted with the aid of the MAC algorithm and taking into account the occupancies of individual queues, with those queues which are assigned to a higher QoS class being read out with priority. Furthermore, the occupancies of the queues of the terminals, for example, are communicated to QoS controller 1, which takes these occupancies into account when mapping the packets to be transmitted. To a terminal whose queues are already quite full, no or only few packets are transmitted for a given period of time, for example.

Furthermore, QoS controller 1 serves to grant rights to transmit for the uplink and to allocate bandwidths or data rates or grant rights to transmit for the downlink, the grants and allocations for the uplink and downlink being determined using the MAC algorithm; for the downlink, the priority determined by the QoS class is additionally taken into account.

QoS controller 1 has an output which is connected to the Internet for the transmission of the uplink information packets.

In the embodiment, the invention is applied to an LMDS network. Instead of an LMDS network, any other bidirectional wireline or wireless point-to-multipoint access network can be used.

In the embodiment, the MAC protocol is used in the uplink. Instead of a MAC protocol, any other protocol can be used in the uplink.

In the embodiment, the QoS controller is used in a base station. Instead of being used in a base station, the QoS controller can be employed at any other point in the network, e.g., in a network node, a hub, a head end, or a terminal.

In the embodiment, the QoS controller is described as incorporating a specific software module. Synonyms for the software module are software component, software package, software, software program, computer program, control section. Instead of a software module, one or more copies of the software module may be present in the QoS controller. This permits parallel processing, whereby the processing speed is increased and simultaneous access by uplink and downlink processing steps to the same software module is prevented. Instead of being present in one QoS controller, one or more copies may be distributed to one or more processors or QoS controllers. This, too, permits parallel processing, whereby the processing speed is increased and simultaneous access by uplink and downlink processing steps to the same software module is prevented. Instead of being distributed to one controller, the software module may be distributed to two or more processors or two or more QoS controllers. Then, each processor or QoS controller has access to only a portion of the software module. This, too, increases the processing speed.

1. A QoS controller for a bidirectional point-to-multipoint access network, particularly for an LMDS network, comprising at least one software module adapted to perform a QoS processing step for both the uplink and the downlink.

2. A QoS controller as set forth in claim 1, wherein the software module uses at least essentially the same algorithm for allocations of resources and QoS management in both the uplink and the downlink.

3. A QoS controller as set forth in claim 1, wherein the QoS controller has the same implementation of at least the essential functions of a MAC QoS controller for allocations of resources and/or QoS management in both the uplink and the downlink.

4. A QoS controller as set forth in claim 1, wherein said QoS controller is adapted to grant transmission rights for the uplink and to allocate bandwidths or data rates for the downlink, the grants and allocations being dependent on occupancies of at least one buffer (3) in which information packets to be transmitted and/or associated pointers and/or MAC messages are stored temporarily, and/or on connection parameters and/or on available transmission capacities and/or on QoS classes.

5. A QoS controller as set forth in claim 1, wherein said QoS controller is adapted to grant transmission rights for the uplink and to allocate bandwidths or data rates or grant transmission rights for downlink, the grants and allocations for the uplink and downlink being determined by means of a MAC algorithm, additionally taking into account for the downlink the priority determined by the QoS class.

6. A base station for an LMDS network, the base station comprising a QoS controller according to claim 1, a series combination of an IP classifier, a buffer, and a downlink framer which are all connected to the QoS controller, and an uplink deframer connected to the QoS controller.

7. A QoS software module for a bidirectional point-to-multipoint access network, particularly for an LMDS network, which is adapted to perform at least one QoS processing step for both the uplink and the downlink.
